(19) United States
(12) Patent Application Publication
(10) Pub. No.: US 2025/0148193 A1
(43) Pub. Date: May 8, 2025

(54) Case Toggle Keyboard and Key

(71) Applicants: Gail M. Morgan, Fort Lauderdale, FL (US); Kirsten Erickson, Fort Lauderdale, FL (US)

(72) Inventors: Gail M. Morgan, Fort Lauderdale, FL (US); Kirsten Erickson, Fort Lauderdale, FL (US)

(21) Appl. No.: 18/814,674

(22) Filed: Aug. 26, 2024

Related U.S. Application Data
(60) Provisional application No. 63/595,510, filed on Nov. 2, 2023.

(51) Int. Cl. G06F 40/166; G06F 3/02

(52) U.S. Cl. CPC G06F 40/166; G06F 3/02

(57) ABSTRACT

An uppercase-lowercase editing override toggle key is disclosed. The key can be part of physical keyboards on computers, laptops, and virtual keyboards on smartphones, computers, and tablets. The key enables users to change the case of typed letters from smaller lowercase to larger uppercase and vice versa. In some embodiments, the key can be in the form of a downloadable software application that can be developed to provide case toggle functionality for devices that lack a hardware key. The key includes an indicium or logo to indicate case toggle functionality of the key. In a physical keyboard, the key includes hardware modifications, software updates, and the development of cross-platform applications in the keyboard.

### CROSS-REFERENCE TO RELATED APPLICATION

The present application claims priority to, and the benefit of, U.S. Provisional Application No. 63/595,510 which was filed on Nov. 2, 2023, and is incorporated herein by reference in its entirety.

### FIELD OF THE INVENTION

The present invention generally relates to the field of keyboards. More specifically, the present invention relates to a novel uppercase-lowercase typing override key. The key can be integrated into physical keyboards on computers, laptops, and virtual keyboards on smartphones and tablets. The key enables to change the case of typed letters from lowercase to uppercase (i.e., train case), and vice versa. The key includes an indicium or logo to indicate case toggle functionality of the key. Accordingly, the present disclosure makes specific reference thereto. Nonetheless, it is to be appreciated that aspects of the present invention are also equally applicable to other like applications, devices, and methods of manufacture.

### BACKGROUND

By way of background, in today's digital age, individuals use personal computing devices on a daily basis. Individuals use such devices for different purposes including, but not limited to, composing emails, drafting lengthy reports, blogs, and more. Desktops, laptops, smartphones, tablets, and more have replaced pen and paper for a vast majority of tasks. Individuals generally use physical keyboards and virtual keyboards for typing in different applications.

However, individuals often found it challenging to write using conventional keyboards. It is common for individuals to type with the Caps Lock key on unintentionally which can lead to entire sections written in uppercase, which is incorrect for most writing. Typos and incorrect capitalization require deleting and re-typing, wasting time and effort. Similarly, when an individual wants to write in caps, accidentally turning off the caps key leads to deletion and re-typing. Deleting and re-typing large text due to incorrect capitalization is not only time-consuming but also disrupts the thought process. Individuals desire a way to change all lowercase typed letters, words, sentences, and paragraphs into all capital letters (i.e., train case), and vice versa easily.

Therefore, there exists a long-felt need in the art for an improved keyboard that enables a user to change all lowercase typed letters, words, sentences, and/or paragraphs into all capital letters, and vice versa. There is also a long-felt need in the art for a key that can be integrated in physical and virtual keyboards for changing lowercase typed letters, words, sentences, and/or paragraphs into all capital letters and vice versa. Additionally, there is a long-felt need in the art for a special or dedicated key that eliminates re-typing large text sections due to incorrect capitalization. Moreover, there is a long-felt need in the art for a uniquely designed functionality in the form of a physical key, virtual key, or an application that can change all lowercase typed letters into all capital letters (i.e., train case), and vice versa. Further, there is a long-felt need in the art for a system that prevents users from having to delete and retype full sentences due to casing mistakes. Furthermore, there is a long-felt need in the art for a keyboard key that provides an easy way to change the case of text on a personal computing device. Finally, there is a long-felt need in the art for a uniquely designed case toggle key or button across various platforms that can significantly enhance user productivity and convenience.

The subject matter disclosed and claimed herein, in one embodiment thereof, comprises a keyboard for a computing device. The keyboard includes a plurality of physical keys, a case toggle key integrated into the keyboard, the toggle key is configured to toggle the case of typed letters, words, sentences, paragraphs, et. al., between lowercase and uppercase, and an indicium positioned on the toggle key representing the case change functionality thereof. The keyboard includes firmware to recognize the case toggle key and send the appropriate signals to an operating system of the computing device. In use, when case toggle key is pressed, the uppercase of a selected text can change to lowercase or the lowercase can change to uppercase.

In this manner, the dedicated case toggle key or button of the present invention accomplishes all of the foregoing objectives and provides users with a novel key that enables users to change the case of typed letters from lowercase to uppercase (i.e., train case), and vice versa. The key can be part of physical keyboards on computers, laptops, and virtual keyboards on smartphones and tablets. Additionally, a downloadable software application can be developed to provide the case toggle functionality for devices that lack a hardware key.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is highlighted (i.e., identified) and presented later.

The subject matter disclosed and claimed herein, in one embodiment thereof, comprises a keyboard for a computing device. The keyboard includes a plurality of physical keys, a case toggle key integrated into the keyboard, the toggle key is configured to toggle the case of typed letters, words, sentences, paragraphs (i.e., highlighted text) between lowercase and uppercase, and an indicium positioned on the toggle key representing the case change functionality thereof. The keyboard includes firmware to recognize the case toggle key and send the appropriate signals to an operating system of the computing device.

In yet another embodiment, a case toggle key for a keyboard is disclosed. The case toggle key comprising an indicium representing the functionality of the key to toggle the case of typed letters between lowercase and uppercase.

In another embodiment, a virtual keyboard displayed on a computing device is disclosed. The virtual keyboard includes a plurality of virtual keys including a virtual case toggle key, the virtual toggle key when pressed is adapted to toggle the case of text displayed on the computing device between lowercase and uppercase.

In another aspect, a method for providing case toggle functionality in an application executable on a computing device is described. The method includes developing an application compatible with multiple operating systems, integrating within the application an algorithm to toggle the case of selected or highlighted text, or word(s) at a cursor position, downloading the application to the computing device for use, and providing an interface within the application including a virtual button to toggle text case.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of an improved keyboard of the present invention with an integrated uppercase-lowercase typing override key in accordance with the disclosed structure;

FIG. 2 illustrates a perspective view showing automatic conversion of case of the text in an application using the uppercase-lowercase typing override key of the present invention in accordance with the disclosed structure;

FIG. 3 illustrates a perspective view showing the uppercase-lowercase typing override virtual key on a virtual keyboard on a computing device in accordance with the disclosed structure;

FIG. 4 illustrates a perspective view showing automatic conversion of case of the text using the uppercase-lowercase typing override virtual key of the present invention in accordance with the disclosed structure; and

FIG. 5 illustrates a flow diagram depicting a process of using a downloadable program or application for computing devices to provide case toggle functionality of the uppercase-lowercase typing override key in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved keyboard that enables a user to change all lowercase typed letters into all capital letters, and vice versa. There is also a long-felt need in the art for a key that can be integrated in physical and virtual keyboards for changing lowercase typed letters into all capital letters and vice versa. Additionally, there is a long-felt need in the art for a special or dedicated key that eliminates re-typing text due to incorrect capitalization. Moreover, there is a long-felt need in the art for a uniquely designed functionality in the form of a physical key, virtual key, or an application that can change all lowercase typed letters into all capital letters (i.e., train case), and vice versa. Further, there is a long-felt need in the art for a system that prevents users from having to delete and retype full sentences due to casing mistakes. Furthermore, there is a long-felt need in the art for a keyboard key that provides an easy way to change case of text on a personal computing device. Finally, there is a long-felt need in the art for a uniquely designed case toggle key or button across various platforms can significantly enhance user productivity and convenience.

The present invention, in one exemplary embodiment, is a method for providing case toggle functionality in an application executable on a computing device. The method includes developing an application compatible with multiple operating systems, integrating within the application an algorithm to toggle the case of selected text or text (i.e., word) at a cursor position, downloading the application to the computing device for use, and providing an interface within the application including a virtual button to toggle text case.

Reference will now be made in detail to the present preferred embodiments of the invention, examples of which are illustrated in the accompanying drawings. Wherever possible, the same reference numerals are used in the drawings and the description to refer to the same or like parts.

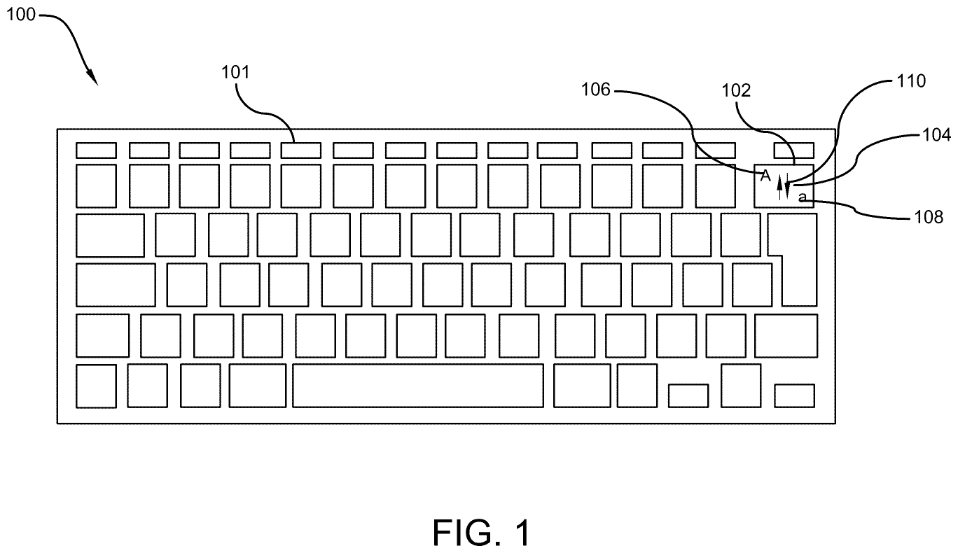

Referring initially to the drawings, FIG. 1 illustrates a perspective view of an improved keyboard of the present invention with an integrated uppercase-lowercase typing override key in accordance with the disclosed structure. The improved keyboard 100 of the present invention is designed to include a plurality of physical keys 101 including a novel key or button 102 that enables users to toggle the case of typed letters from lowercase to uppercase and vice versa. The toggle key 102 is integrated into the physical keyboard 100 of computers, laptops, and other similar devices. The uppercase-lowercase typing override key 102 is positioned at an optimal location on the keyboard 100 and includes an indicia or logo 104 thereon to represent case change functionality thereof. The keyboard 100 includes an updated firmware to recognize the toggle key 102 and send the appropriate signals to the operating system of the computing system to which the keyboard 100 is operatively connected, via USB or otherwise. In the preferred embodiment, the indicium 104 includes an uppercase notation 106, a lowercase notation 108, and a toggle sign 110 indicating case toggle functionality.

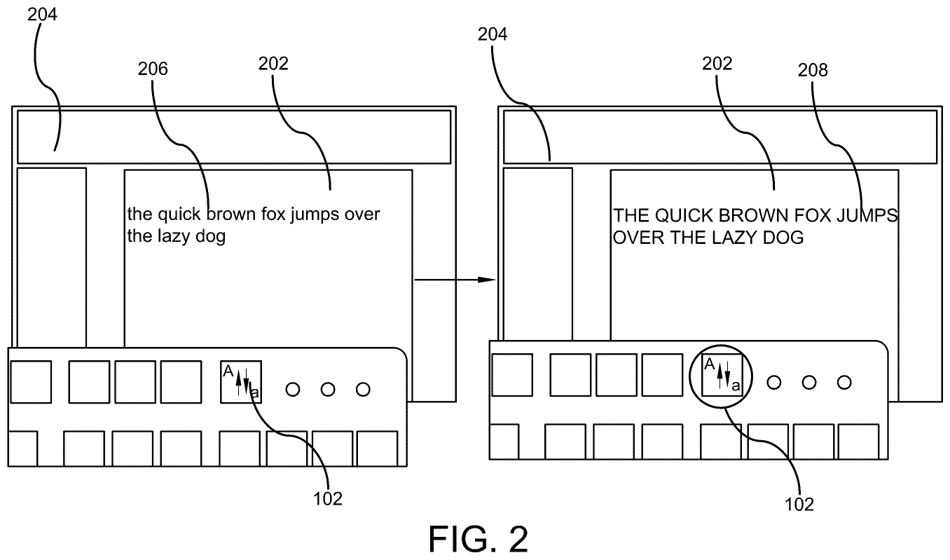

FIG. 2 illustrates a perspective view showing automatic conversion of case of the text in an application using the uppercase-lowercase typing override key of the present invention in accordance with the disclosed structure. As illustrated, an application 202 on the computing system 204 displays the text 206 in lowercase and when the uppercase-lowercase typing override key 102 is pressed like a conventional keyboard key, the lowercase text 206 is converted into uppercase or caps 208. In some embodiments, case is changed for the text selected or highlighted (i.e., identified) by the user, and in other embodiments, text (i.e., word) at the cursor position changes its case. In alternative embodiments, all the editable text that is highlighted (i.e., identified) and present in the application changes case when the uppercase-lowercase typing override key 102 is pressed.

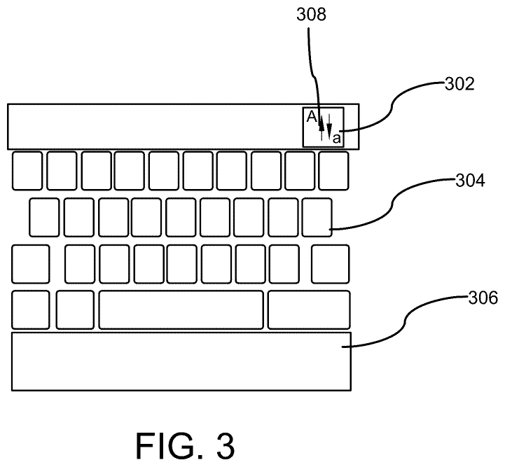

FIG. 3 illustrates a perspective view showing the uppercase-lowercase typing override virtual key on a virtual keyboard on a computing device in accordance with the disclosed structure. In the present embodiment, a virtual key 302 is included in the virtual keyboard 304 for representing the case toggle functionality. The layout of the keyboard 304 is updated to include the toggle key 302. The key 302 is adapted to use APIs provided by the operating system of the computing device 306 such as a smartphone, tablet, computer, smartwatch, or any other wearable device to change the case of the text in the text input fields. Application programming interfaces (APIs) are a set of functions and procedures allowing the creation of applications that access the features or data of an operating system, application, or other service.

The virtual key 302 is positioned in an accessible and intuitive position on the virtual keyboard 304. The key 302 also includes an indicium or logo 308 for indicating case toggle functionality of the key 302.

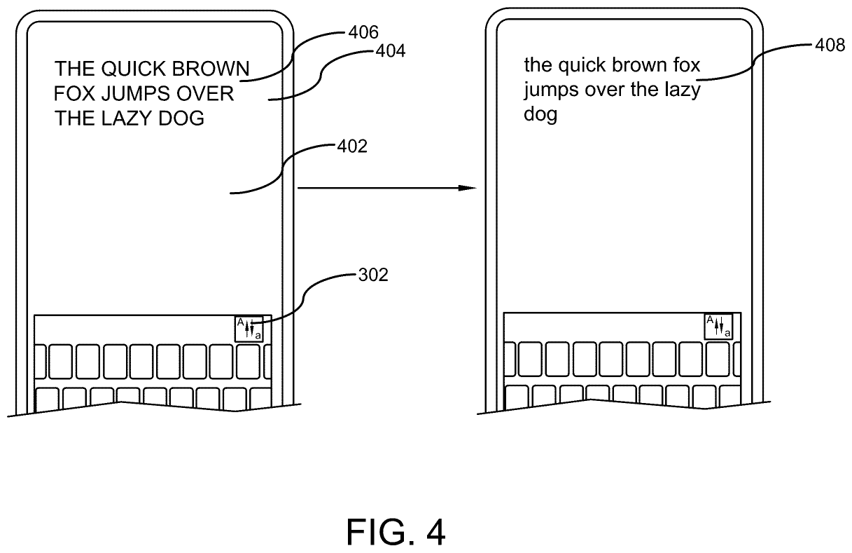

FIG. 4 illustrates a perspective view showing automatic conversion of case of the text using the uppercase-lowercase typing override virtual key of the present invention in accordance with the disclosed structure. As illustrated, an application 402 on the electronic device 404 displays the text 406 in caps and when the uppercase-lowercase typing override virtual key 302 is pressed like a conventional virtual key, the uppercase text 406 is converted into lowercase 408, or vice versa. In some embodiments, the case is changed for the text selected or highlighted (i.e., identified) by the user, and in other embodiments, text (i.e., word) at the cursor position changes its case. In alternative embodiments, all the editable text that is highlighted (i.e., identified) and present in the application changes case when the uppercase-lowercase typing override virtual key 302 is pressed.

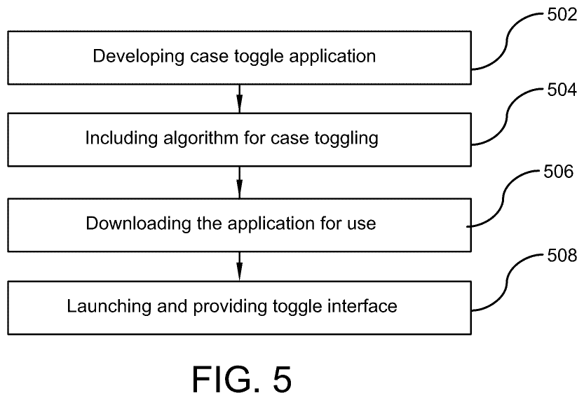

FIG. 5 illustrates a flow diagram depicting a process of using a downloadable program or application for computing devices to provide case toggle functionality of the uppercase-lowercase typing override key in accordance with the disclosed structure. Initially, an application compatible to different operating systems such as Windows, macOS, Linux, iOS, and Android are developed (Step 502). In the application, an algorithm or instructions to toggle the case of selected text or the text (i.e., word) at the cursor position is included (Step 504). Then, the application is downloaded to a system for use (Step 506). Finally, the application is launched and an interface is provided by the application which includes a virtual button to toggle text case (Step 508).

For example, in iOS, the toggle key can be implemented using UIInput ViewController subclass. For Android, the InputMethodService class can be used to create a custom keyboard layout with the case toggle key.

It will be apparent to a person skilled in the art that the case toggle key involves hardware modifications, software updates, and the development of cross-platform applications to ensure broad accessibility and ease of use. The key (both physical and virtual) of the present invention saves users time and effort by providing a simple way to correct text case errors without the need to retype entire sentences. The toggle key can be made in different colors and may illuminate enabling user to easily access the key.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “uppercase-lowercase typing override key integrated keyboard”, “uppercase-lowercase typing override key integrated virtual keyboard”, “improved keyboard”, and “virtual keyboard” are interchangeable and refer to the uppercase-lowercase typing override key integrated keyboard 100, 304 of the present invention. Similarly, as used herein “uppercase-lowercase typing override key”, “case toggle key”, “toggle key”, “key”, and “virtual key” are interchangeable and refer to the uppercase-lowercase typing override key 102, 302 of the present invention.

Notwithstanding the foregoing, the uppercase-lowercase typing override key integrated keyboard 100, 304 and the uppercase-lowercase typing override key 102, 302 of the present invention can be of any suitable size and configuration as is known in the art without affecting the overall concept of the invention, provided that it accomplishes the above-stated objectives. One of ordinary skill in the art will appreciate that the uppercase-lowercase typing override key integrated keyboard 100, 304 and the uppercase-lowercase typing override key 102, 302 as shown in the FIGS. are for illustrative purposes only, and that many other sizes and shapes of the uppercase-lowercase typing override key integrated keyboard 100, 304 and the uppercase-lowercase typing override key 102, 302 are well within the scope of the present disclosure. Although the dimensions of the uppercase-lowercase typing override key integrated keyboard 100, 304 and the uppercase-lowercase typing override key 102, 302 are important design parameters for user convenience, the uppercase-lowercase typing override key integrated keyboard 100, 304 and the uppercase-lowercase typing override key 102, 302 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A keyboard function for changing case of typed letters comprising:
a key on a keyboard;
an indicia; and
an application;
wherein said indicia identifies said key;
wherein said key is a toggle key; and
further wherein actuation of said toggle key operates said application for changing a highlighted text selectively between lowercase letters and uppercase letters.

2. The keyboard function for changing case of typed letters of claim 1, wherein said indicia identifies said toggle key as a case function change key.

3. The keyboard function for changing case of typed letters of claim 2, wherein said indicia having an uppercase notation and a lowercase notation.

4. The keyboard function for changing case of typed letters of claim 3, wherein said indicia having a toggle notation for indicating case functionality of said key.

5. The keyboard function for changing case of typed letters of claim 4, wherein said toggle key is a virtual key.

6. The keyboard function for changing case of typed letters of claim 5, wherein said keyboard is a virtual keyboard.

7. A method for changing the case of typed letters, the method comprising the steps of:
providing a keyboard and an application, wherein said keyboard having a key;
identifying said key with an indicia, wherein said key is a toggle key;
highlighting a text area;
actuating said toggle key; and
operating said application for changing said highlighted text area selectively from lowercase letters to uppercase letters, or from uppercase letters to lowercase letters.

8. The method for changing the case of typed letters of claim 7, wherein said indicia identifies said toggle key as a case function change key.

9. The method for changing the case of typed letters of claim 8, wherein said indicia having an uppercase notation and a lowercase notation.

10. The method for changing the case of typed letters of claim 9, wherein said indicia having a toggle notation for indicating case functionality of said key.

11. The method for changing the case of typed letters of claim 10, wherein said toggle key is a virtual key.

12. The method for changing the case of typed letters of claim 11, wherein said keyboard is a virtual keyboard.

13. A method for changing the case of typed letters, the method comprising the steps of:
providing a keyboard, an application, an API, and an operating system, wherein said keyboard having a key;
identifying said key with an indicia, wherein said key is a toggle key;
highlighting a text area;
actuating said toggle key; and
operating said API and said application for toggling said highlighted text area between lowercase letters and uppercase letters.

14. The method for changing the case of typed letters of claim 13, wherein said operating system having a computing device selected from the group consisting of a smartphone, a tablet, a computer, and a smartwatch.

15. The method for changing the case of typed letters of claim 14, wherein said indicia identifies said toggle key as a case function change key.

16. The method for changing the case of typed letters of claim 15, wherein said indicia having an uppercase notation and a lowercase notation.

17. The method for changing the case of typed letters of claim 16, wherein said indicia having a toggle notation for indicating case functionality of said key.

18. The method for changing the case of typed letters of claim 17, wherein said toggle key is a virtual key.

19. The method for changing the case of typed letters of claim 18, wherein said keyboard is a virtual keyboard.

20. The method for changing the case of typed letters of claim 13, wherein said highlighted text area is a word.
